(19) United States
(12) Patent Application Publication
(10) Pub. No.: US 2014/0359382 A1
(43) Pub. Date: Dec. 4, 2014

(54) MEMORY CONTROLLER AND OPERATING METHOD PROVIDING REPLACEMENT BLOCK FOR BAD BLOCK

(71) Applicant: SHIN-HO CHOI, SEOUL (KR)

(72) Inventor: SHIN-HO CHOI, SEOUL (KR)

(21) Appl. No.: 14/201,025

(22) Filed: Mar. 7, 2014

(30) Foreign Application Priority Data
Jun. 3, 2013 (KR) 10-2013-0063571

(51) Int. Cl. G06F 11/20

(52) U.S. Cl. CPC G06F 11/2094
USPC 714/710

(57) ABSTRACT

An operating method for a memory controller that controls operation of a nonvolatile memory device that stores data according to a plurality of multiple blocks includes; determining that a block among the plurality of blocks is a bad block, and then determining a type of the bad block, determining a number of free blocks, and providing a replacement block to the nonvolatile memory device for the bad block using a replacement block provision policy that is responsive to the type of the bad block and the number of free blocks.

### CROSS-REFERENCE TO RELATED APPLICATION

This application claims priority under 35 U.S.C. 119 from Korean Patent Application No. 10-2013-0063571 filed on Jun. 3, 2013, the subject matter of which is hereby incorporated by reference.

### TECHNICAL FIELD

The inventive concept relates generally to memory controllers capable of controlling nonvolatile memory device(s) and operating methods for memory controllers.

### BACKGROUND

Memory cells in contemporary nonvolatile memory devices are often arranged according to a number blocks. Many nonvolatile memory devices including flash memory devices are known to develop—due fabrication errors or later operating conditions—one or more nonfunctional (or “bad”) blocks. It is necessary to manage the operation of a memory system in view of these bad blocks. However, any approach taken to the management or compensation for bad blocks in a memory system should consume a minimum of scarce hardware resources, such as available memory space.

### SUMMARY

Certain embodiments of the inventive concept are directed to memory controllers including a bad block management unit. Certain embodiments of the inventive concept are directed to operating methods for memory controllers that efficiently provide a replacement block for a block determined to be a bad block.

In one embodiment, the inventive concept provides a memory controller that controls operation of a nonvolatile memory device that stores data according to a plurality of blocks, the memory controller comprising; a bad block management unit that provides a replacement block as a substitute for a block determined to be bad block, wherein the bad block management unit includes, a replacement block requester that determines that a block among the blocks of the nonvolatile memory device is a bad block, and upon determining that the block is a bad block requests a replacement block, and a replacement block provider responsive to the request of the replacement block requester and controlled by a replacement block provision policy that provides the replacement block for the bad block by considering a type of the block and a current number of free blocks.

In another embodiment, the inventive concept provides an operating method for a memory controller that controls the operation of a nonvolatile memory device that stores data according to a plurality of multiple blocks, the method comprising; determining that a block among the plurality of blocks is a bad block, and then, determining a type of the bad block, and determining a number of free blocks, and providing a replacement block to the nonvolatile memory device for the bad block using a replacement block provision policy that is responsive to the type of the bad block and the number of free blocks.

### BRIEF DESCRIPTION OF THE DRAWINGS

The above and other features and advantages of the inventive concept will become more apparent upon consideration of certain illustrated embodiments thereof with reference to the attached drawings in which:

FIG. 1 is a block diagram of an electronic device including a nonvolatile memory system according to an embodiment of the inventive concept;

FIG. 2 is a block diagram further illustrating one example of the memory system of FIG. 1;

FIG. 3 is a block diagram further illustrating the bad block management unit of FIG. 2;

FIG. 4 is a conceptual diagram illustrating an operation method of a bad block management unit of a memory controller according to an embodiment of the inventive concept;

FIG. 5 is a conceptual diagram illustrating an operation method of a bad block management unit of a memory controller according to another embodiment of the inventive concept;

FIG. 6 is a conceptual diagram illustrating a bad block management method of a memory controller according to another embodiment of the inventive concept;

FIGS. 7, 8 and 9 are respective flowcharts summarizing in various examples operating method(s) for a bad block management unit according to certain embodiments of the inventive concept;

FIGS. 10, 11, 12, 13, 14 and 15 are respective block diagrams of various electronic device that may incorporate a memory controller and a nonvolatile memory device according to embodiments of the inventive concept.

### DETAILED DESCRIPTION OF EMBODIMENTS

Embodiments of the inventive concept will now be described in some additional detail with reference to the accompanying drawings. The inventive concept may, however, be embodied in many different forms and should not be construed as being limited to only the illustrated embodiments. Rather, the illustrated embodiments are provided so that this disclosure will be thorough and complete and will filly convey the scope of the inventive concept to those skilled in the art. Throughout the written description and drawings, like reference numbers and labels are used to denote like or similar elements, components and/or features.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Terms like “a”, “an” and “the” and similar articles in the context of the following written description of the illustrated embodiments, and also in the context of the following claims should be broadly construed to cover both singular and plural example, unless otherwise indicated. In like manner, terms like “comprising,” “having,” “including,” and “containing” should be construed as open-ended terms meaning “including, but not limited to”, unless otherwise noted.

Unless defined otherwise, all technical and scientific terms used herein have the same meaning as commonly understood by those skilled in the art to which the inventive concept belongs. It is noted that the use of any and all examples, or exemplary terms provided herein is intended merely to better illuminate the inventive concept and is not a limitation on the scope of the inventive concept unless otherwise specified. Further, unless defined otherwise, all terms defined in generally used dictionaries should not be interpreted in an overly strict manner.

Certain embodiments of the inventive concept may be described with reference to perspective views, cross-sectional views, and/or plan views. It will be understood that the profile of an exemplary view may be modified according to conventionally understood manufacturing techniques and/or allowances. That is, the illustrated embodiments of the inventive concept are not intended to necessarily limit the scope of the inventive concept. Rather, changes and modifications to the illustrated embodiments as required by changes or evolution in manufacturing process are covered by the scope of the inventive concept.

Upon consideration of the written description, drawings and claims, those skilled in the art will appreciate that many variations and modifications may be made to the illustrated embodiments without substantially departing from the principles of the inventive concept. Therefore, the illustrated embodiments of the inventive concept should be construed in a generic and descriptive sense only and not for purposes of limitation.

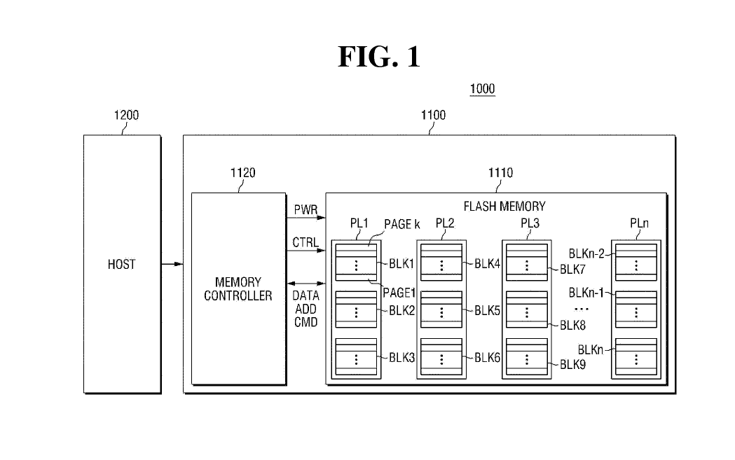

Figure (FIG. 1 is a block diagram of an electronic device 1000 including a nonvolatile memory system 1100 according to an embodiment of the inventive concept.

Referring to FIG. 1, the electronic device 1000 includes a host 1200 and the nonvolatile memory system 1100. The host 1200 may be an electronic device, for example, a personal computer (PC), a digital camera, a camcorder, a cellular phone, a smart phone, a tablet PC, a portable device, an MP3, a portable multimedia player (PMP), a play station portable (PSP), a personal digital assistant (PDA), and an email transceiving device. The nonvolatile memory system 1100 includes a memory controller 1120 and a nonvolatile memory device 1110. The memory controller 1120 overall controls the nonvolatile memory device 1110. The nonvolatile memory device 1110 may perform an erase, a write, or a read operation according to control of the memory controller 1120. To this end, the nonvolatile memory device 1110 receives a command (CMD), an address (ADD), and data (DATA) through an input/output line. Also, the nonvolatile memory device 1110 receives power (PWR) through a power line and receives a control signal (CTRL) through a control line. The control signal (CTRL) may include, for example, command latch enable (CLE), address latch enable (ALE), chip in-enable (nCE), write enable (nWE), and read enable (nRE).

The nonvolatile memory device 1110 may include one or more of a flash memory, an electrically erasable programmable read only memory (EEPROM), a ferroelectrics random access memory (FRAM), a phase change random access memory (PRAM), and a magneto resistive random access memory (MRAM). Although a NAND flash memory device is illustrated as an example in FIG. 1, the scope of the inventive concept is not limited thereto.

Referring to FIG. 1, the nonvolatile memory device 1110 may serve as a storage unit configured to store data provided from the memory controller 1120. The nonvolatile memory device 1110 may include a plurality of memory cell arrays configured to store data. Each of the memory cell arrays may include a plurality of planes PL1 through PLn, where ‘n’ is a natural number, and where each of the planes PL1 through PLn may include a plurality of blocks BLK1 through BLKm, where ‘m’ is a natural number. Each of the blocks BLK1 through BLKm may include a plurality of pages PAGE1 through PAGEk, where ‘k’ is a natural number. Each of the blocks BLK1 through BLKm may be designated as an erase unit, wherein all of the memory cells of the erase unit are erased as a group in response to an erase command. In contrast, each of the pages PAGE1 through PAGEk may be designated as a program unit and/or a read unit (“program/read unit”), wherein the memory cells of the program/read unit may be programmed/read in response to a program/read command.

Certain ones of the plurality of blocks BLK1 through BLKm may be used to store user-defined data (alternating termed “general” or “payload” data) provided from the host 1200. Other ones of the plurality of blocks BLK1 through BLKm may be used to stored memory system control/management data, such as error correction data, metadata, address mapping data, etc.

Those skilled in the art will recognize that the constituent memory cells of any particular memory cell array (or portion of a memory cell array) may be operated as single-level cells (SLC) capable of storing a single data bit per memory cell, or as multi-level cells (MLC) capable of storing 2 or more data bits per memory cell. For example, a block of SLC may be used to store particularly critical memory system control/management data (e.g., metadata), while other blocks of MLC may be used to store user-defined data.

It is well understood that one or more defects may occur in one or more of the defined blocks of a nonvolatile memory device dues to a variety of reasons (e.g., column fail, read/program disturbance, memory cell wear-out). A block including one or more defect(s) (hereafter, singularly or collectively referred to as “defect”) is referred as a “bad block”. When a previously designated “normal block” (i.e., a block lacking defect) becomes a bad block, the nonvolatile memory device 1110 may fail to properly execute a program/read command directed to memory cell of the bad block. In such an occurrence, the nonvolatile memory device 1110 will communicate a command execution failure signal to the memory controller 1120.

In response to the command execution failure signal, the memory controller 1120 will classify the bad block according to a number of classification criteria. Henceforth, data may not be stored in a block classified as a bad block, and functionally, the bad block must be replaced with a normal block. Accordingly, the memory controller 1120 will control the nonvolatile memory device 1110 to provide a “replacement block” for the bad block, where the replacement block is selected from a pool of “free block(s)”. More specifically, by mapping the addressed of the bad block onto the replacement block, it is possible to functionally replace the bad block with the replacement block. Specialty software/firmware known as a flash translation layer (FTL) may be used to convert the logical address(es) previously associated with the bad block into corresponding physical address(es) for the memory cells of the replacement block by essentially updating an address mapping table. This type of readily updatable address mapping table may be stored in a random access memory (RAM) or a designated portion of the nonvolatile memory device 1110. After substitution of the replacement block for the bad block, data access requests directed to memory cells of the bad block will essentially be redirected to corresponding memory cells of the replacement block (e.g., by operation of FTL remapping function(s) that refer to the updated mapping table).

It should be noted in relation to embodiments of the inventive concept that by using the foregoing approach of effectively substituting a replacement block—possibly recycled from a pool of free bocks—for a bad block, the memory space provided by the nonvolatile memory device 1110 need not be defined in such a manner that one or more “reserve block(s)” are separately designated. Accordingly, it is possible to increase the available memory space that the nonvolatile memory device 1110 is able to routinely provide. In other words, pre-designated reserve blocks that are conventionally substituted for bad blocks need not be allocated within nonvolatile memory devices according to embodiments of the inventive concept.

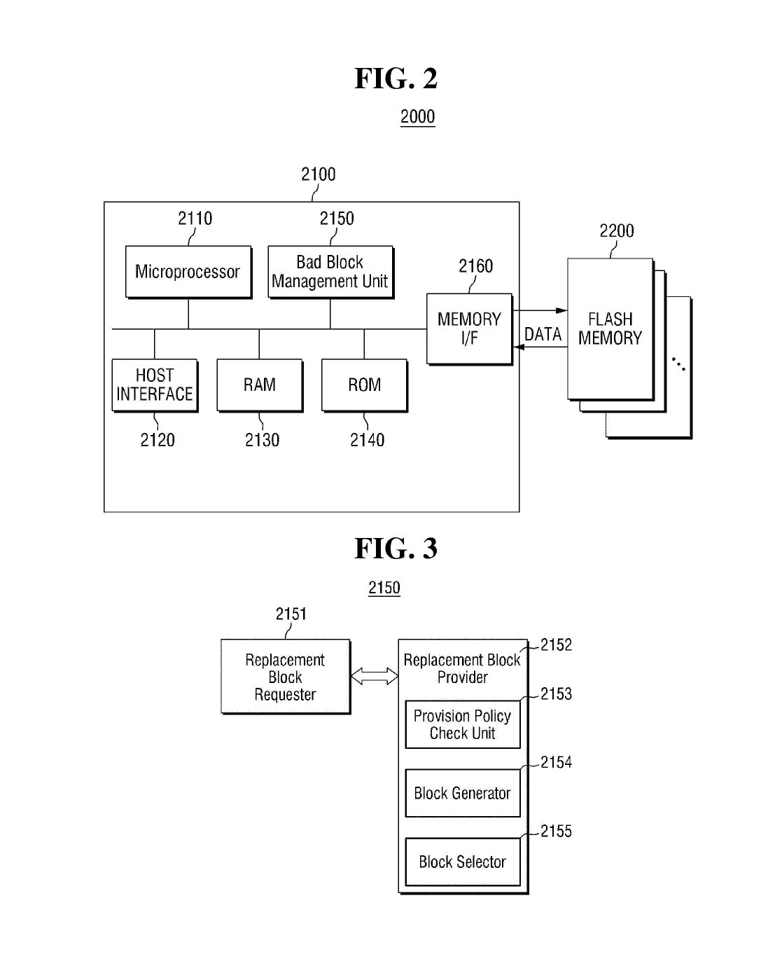

FIG. 2 is a block diagram illustrating a memory system 2000, similar to the memory system 1100 of FIG. 1.

Referring to FIG. 2, the memory system 2000 includes one or more nonvolatile memory device(s) 2200 (hereafter, collectively or singularly referred to as “memory device 2200”) and a memory controller 2100.

In certain embodiments of the inventive concept, the nonvolatile memory device 2200 may be similar to the nonvolatile memory device 1110 described in relation to FIG. 1. Referring to FIG. 2, the nonvolatile memory device 2200 is assumed to be a NAND flash memory device that may be used as a data storage unit configured to store user-defined data provided from the memory controller 2100, and/or control/management data related to the operation of the memory controller 2100 and memory system 2000.

The memory controller 2100 of FIG. 2 comprises a microprocessor 2110, a RAM 2130, a read only memory (ROM) 2140, a host interface 2120, a memory interface (I/F) 2160, and a bad block management unit 2150. These elements of the memory controller 2100 are electrically connected via one or more bus(es).

The host interface 2120 creates an interface between the memory controller 2100 and a connected host, and may be used to provide logical address(es), a command latch enable (CLE) signal, an address latch enable (ALE) signal, a ready and busy (R/B) signal, a chip in-enable (CE) signal as received from the host. Additionally, the host interface 2120 may communicate data, commands, control signal(s) with the host according to a predetermined protocol, such as a universal serial bus (USB), a small computer system interface (SCSI), a PCI express, an ATA, a parallel ATA (PATA), a serial ATA (SATA), and a serial attached SCSI (SAS), etc.

The ROM 2140 may be used to store a driving firmware code for the memory system 2000. A driving firmware code may also or alternately be stored in the nonvolatile memory device 2200. Accordingly, control or intervention by the controlling microprocessor 2110 may be a function of firmware or software driven by the microprocessor 2110 as well as direct control by the microprocessor 2110 in terms of hardware resources.

The RAM 2130 may be configured from a volatile memory and may serve as a buffer storing a command, address, and/or data information received via the host interface 2120. Thus, a command and related information constituting a replacement block request issued by the host, upon the determination of a bad block, may initially be stored in the RAM 2130 as communicated via the host interface 2120. Additionally, the RAM 2130 may be used to temporarily store “read data” provided by the nonvolatile memory device 2200 in response to a read command, and/or “write data” to be written to the nonvolatile memory device 2200.

The microprocessor 2110 may be configured from one or more circuit(s), logic component(s) and/or programming code. The microprocessor 2110 may be used to control the overall operation of the memory system 2000. When power is applied to the memory system 2000, the microprocessor 2110 may begin control the operation of the memory system 2000 by driving certain software/firmware components to the RAM 2130 as provided from the ROM 2140. Microprocessor 2110 may also be used to interpret command(s) received via the host interface 2120 and control the operation of the nonvolatile memory device 2200 based on the interpretation result. The microprocessor 2110 may also be used to map logical address(es) provided from the host onto corresponding physical address(es) of the nonvolatile memory device 2200 using (e.g.,) one or more address mapping table(s).

The memory interface 2160 may be used to control the exchange of data and information between the memory controller 2100 and nonvolatile memory device 2200. Command(s) and/or control signals generated by the microprocessor 2110 may be provided to the nonvolatile memory device 2200 via the memory interface 2160. Read data and write data may also be communicated from the memory controller 2100 to the nonvolatile memory device 2200 using the memory interface 2160.

Recalling the description of bad block detection, classification and management given above with respect to FIG. 1, the following further description of the memory system 2000 assumes that a defect has been determined for a particular block of the nonvolatile memory 2200, and that the block has accordingly been designated a bad block in response to a command execution failure signal communicated from the nonvolatile memory device 2200 to the memory controller 2100.

In this context, and with further reference to FIG. 3, the bad block management unit 2150 includes a replacement block requester 2151 configured to request a replacement block that may be substituted for the bad block, and a replacement block provider 2150. These two (2) related control blocks may be provided by the hardware/software resources of the memory controller 2100. However, in certain embodiments some portion of the bad block management unit 2150 may be provide by a portion of the control logic that controls the operation of the nonvolatile memory device 2200.

Consistent with the previous description, data can no longer be stored in a block once it is designated (or classified) as a bad block with the nonvolatile memory device 2200. Hence, a replacement block (i.e. an available normal block) must functionally substituted for the bad block. Accordingly, the memory controller 2100 of FIG. 2 may select a free block, designate the free block as the required replacement block, and thereafter operate in such a manner that the replacement block appears to be the bad block, other than its defect.

Thus, upon determination of a bad block, the bad block management unit 2150 will substitute the replacement block for the bad block, wherein provision of the replacement block is controlled according to a replacement block provision policy that may involve consideration of one or more replacement block criteria. For example, a replacement block provision policy may take into account both the type of the bad block and the number of free blocks. Thus, if the bad block stores user-defined data, the bad block management unit 2150 must provide the replacement block, regardless of the number of free blocks.

A replacement block provision policy may determine the extent and/or nature of operations that must immediately be performed as part of the providing the replacement block. For example, if the number of free blocks currently designated by the nonvolatile memory device 2200 is less than a minimum threshold, the bad block management unit 2150 may be required to immediately (or as soon as allowed by a given operations priority) create at least one “additional free block” by (e.g.,) performing copy/merge operation(s) on one or more blocks of the nonvolatile memory 2200 in order to create the additional free block. This requirement may, under criteria of the replacement block provision policy, be required before the replacement block can be created. That is, the bad block management unit 2150 may replace the bad block with the replacement block only after the number of free blocks equals or exceeds the minimum threshold. Thereafter, the logical address(es) corresponding to the bad block may be converted into corresponding physical address(es) of the replacement block during an address update routine directed to an address mapping table and controlled by a constituent FTL.

It should be noted at this point that although the bad block management unit 2150 of FIG. 2 is illustrated as a separate hardware/software component from the microprocessor 2110, this need not be the case and those skilled in the art will understand that one or more hardware/software resources may be commonly used between the microprocessor 2110 and the bad block management unit 2150. In fact in certain embodiments, the functionality described herein in relation to the bad block management unit 2150 may be fully subsumed in the operation of the microprocessor 2110.

Referring again to FIG. 3, the replacement block requester 2151 may be used to determine the occurrence of a bad block of the nonvolatile memory device 2200. In response to a positive determination, the replacement block requester 2151 may be used to request a replacement block from the replacement block provider 2152.

The replacement block provider 2152 illustrated in FIG. 3 functionally comprises a provision policy check unit 2153, a block generator 2154, and a block selector 2155. In response to a request by the replacement block requester 2151, the replacement block provider 2152 controls the execution of certain operations required to substitute a replacement block for the bad block. Thus, the provision policy check unit 2153 may be used to select a free block available in the nonvolatile memory device 220 according to a given replacement block provision policy. As part of a replacement block provision policy, the provision policy check unit 2153 may determine a “type” for the bad block. Type may be determined according to the particular usage of the bad block. Thus, as examples, different block types may include; a user-defined data block, a metadata block, and a critical data backup block, etc. As another part of a replacement block provision policy, the provision policy check unit 2153 may determine a current number of free blocks. This number may include a number of free blocks in a particular plane including the bad block, or a number of free blocks in a given plurality of planes within the nonvolatile memory device 2200.

According to certain embodiments of the inventive concept, when the type of the bad block is determined to be a user-defined data block, the provision policy check unit 2153 will select a replacement block regardless of the current number of free blocks. Accordingly, the replacement block provider 2152 may immediately substitute the replacement block for the bad block, regardless of the current number of free blocks.

According to certain embodiments of the inventive concept, when the current number of free blocks is less than a minimum threshold, the block generator 2154 may be used to generate a free block from existing block by performing one or more copy/merge operations. A free block generated in this manner may then be designated as a replacement block for the bad block. It should be noted in this regard, the free block(s) may be routinely generated by performing garbage collection operations that copy/merge valid pages from at least first and second blocks, thereby allowing the erasing of at least one of the first and second blocks to form a new free block.

The block selector 2155 may be used to actually provide (or substitute) the replacement block for the bad block by mapping address(es) of the bad block onto corresponding address(es) of the replacement block. In this manner, the data stored in the bad block is replicated for subsequent data accesses in the replacement block.

In conjunction with this provisioning process, the FTL of the memory system 200 may be used to update one or more address mapping table(s) so that the logical address(es) once indexing the memory cells of the bad block instead index the memory cells of the replacement bloc. As has been described above, the address mapping table(s) may be maintained in the RAM 2130 or the nonvolatile memory device 2200. Accordingly, all logical address(es) contained in subsequently received data access requests will be converted by the FTL into corresponding physical address(es) of the replacement block.

According to another embodiment of the inventive concept, the provision policy check unit 2153 may be used to determine in combination (a) that the bad block is a metadata block and (b) a current number of free blocks in relation to (e.g.,) a plane including the bad block or a designated plurality of planes. If the current number of free blocks is less than a first threshold ‘N1’, the provision policy check unit 2153 will not immediately provide the replacement block, but will instead set replacement block request information by storing a “pending replacement block request” in the RAM 2130 or by incrementing a “pending replacement block request count”.

Later, perhaps during a standby period for the memory system 200, the provision policy check unit 2153 may determine the current number of free blocks available in the nonvolatile memory device 2200. When the current number of free blocks is greater than or equal to the first threshold N1, the block selector 2155 may merely select a replacement block from among the free blocks and provide the selected replacement block as a substitute for the bad block in the manner described above. Thereafter, any setting of the replacement block request information may be released.

According to still another embodiment of the inventive concept, when the nonvolatile memory device 2200 comprises a memory cell array having memory cell used in various blocks as at least three-bit MLC, it is often advisable to provide a SLC backup block. Assuming this configuration, the provision policy check unit 2153 may be used to determine whether the SLC backup block is a bad block, and the current number of free blocks. When the current number of free blocks is less than a first threshold M1, the provision policy check unit 2153 need not immediately provide the replacement block, but again may instead set replacement block request information or increment a replacement block request count, as above. However, when the current number of free blocks is greater than the first threshold M1, the provision policy check unit 2153 may simply provide the replacement block.

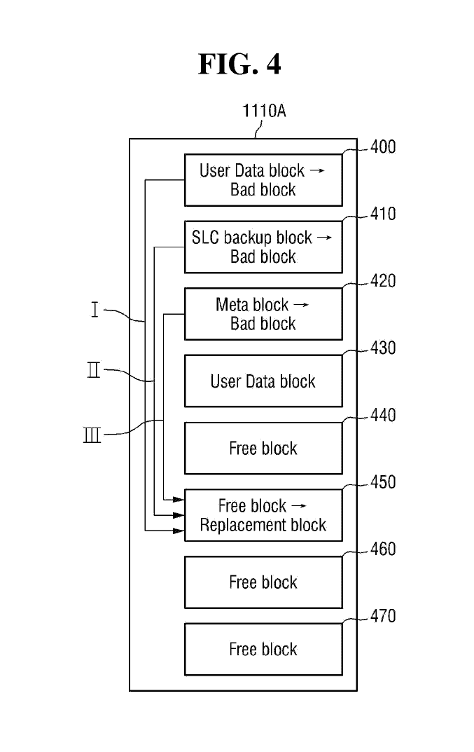

FIG. 4 is a conceptual diagram illustrating in one example operation of the bad block management unit 2150 according to an embodiment of the inventive concept. Referring to FIG. 4, a single plane 1110A of a nonvolatile memory device is assumed to include multiple and different type bad blocks (e.g., 400, 410, and 420) in addition a normal user-defined data block 430, a free blocks 440, 450, 460, and 470, wherein free block 450 is selected as a replacement block. Here, user-defined data block 400 is determined to be a bad block, SLC backup data block 410 is determined to be a bad block, and metadata block 420 is also determined to be a bad block.

In response to a determination of at least one bad block in the nonvolatile memory device 2200, the replacement block requester 2151 increments a replacement block request count. The provision policy check unit 2153 then determines whether it is possible to provide a replacement block based on the type of bad block and the current number of free blocks. In relation to the example illustrated in FIG. 4, it is initially assumed that the current number of free blocks (i.e., 4) is greater than or equal to a minimum threshold. Accordingly, regardless of the bad block type, the provision policy check unit 2153 selects a replacement block (i.e., free block 450) using the block selector 2155 and provides the replacement block as a substitute for the first determined bad block (e.g., user-defined data block 400 in case I, or SLC backup block 410 in case II, or metadata block 420 in case III) in the manner described above (e.g., mapping the address(es) of the bad block onto corresponding address(es) of the replacement block).

As has been noted above, even though FIG. 4 conceptually illustrates only a single plane 1110A including bad blocks, the provision policy check unit 2153 may determine whether to provide a replacement block based on a current number of free blocks available across a predetermined plurality of planes of the nonvolatile memory device 2200.

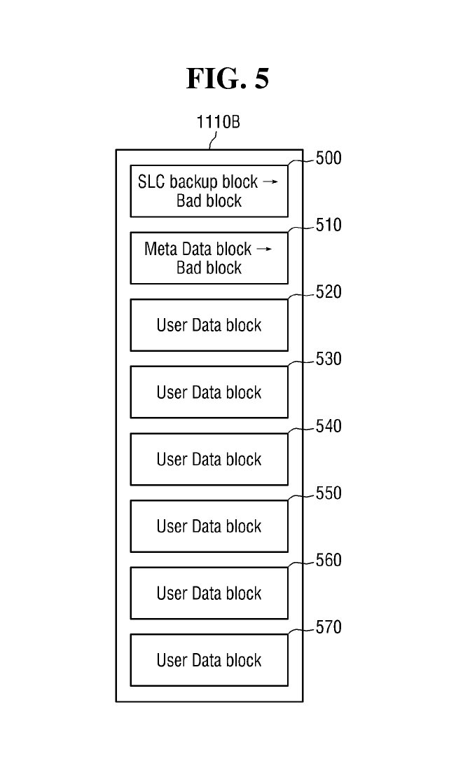

FIG. 5 is a conceptual diagram illustrating in one example an operating method for the bad block management unit 2150 of the memory controller 2100 according to another embodiment of the inventive concept.

Referring to FIG. 5, as an example, a single plane 1110B includes an SLC backup block 500, a metadata block 510, and user data blocks 520, 530, 540, 550, 560, and 570. First the SLC backup block 500 is determined to be a bad block, and then the metadata block 510 is determined to be a bad block.

Under these assumptions, when the SLC backup block is first determined to be a bad block, the replacement block requester 2151 will not immediately provide a replacement block because there are not free blocks available in plane 1110B. Rather, the replacement block requester 2151 merely increments a replacement block request count, once the provision policy check unit 2153 determines whether it is possible to provide a replacement block based on bad block type and the current number of free blocks within the plane 1110B. That is, since the corresponding plane 1110B does not include a current number of free blocks greater than or equal a given minimum threshold, the provision policy check unit 2153 merely sets replacement block request information by storing a replacement block request in the RAM 2130 or by increasing the replacement block request count. Later, the provision policy check unit 2153 may determine that a number of free blocks available in the nonvolatile memory device 2200 is sufficient to provide the requested replacement block.

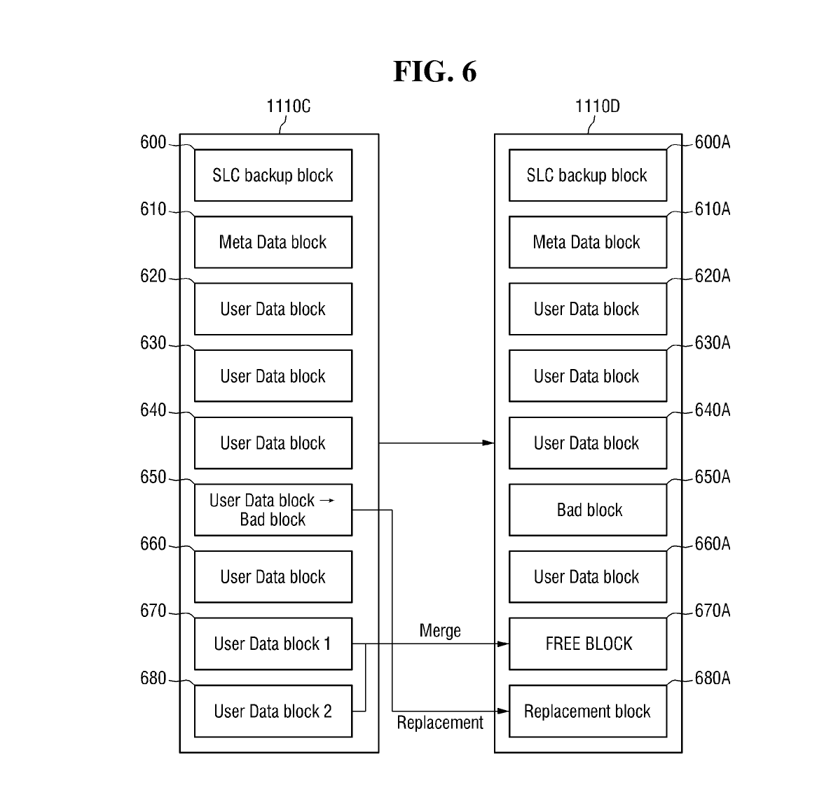

FIG. 6 is a conceptual diagram illustrating a bad block management method that may be implemented by the memory controller 2100 according to another embodiment of the inventive concept.

Referring to FIG. 6, a first plane 1110C is assumed to include an SLC backup block 600, a metadata block 610, and user-defined data blocks 620, 630, 640, 650, 660, 670, and 680, where the user-defined data block 650 is determined to be a bad block. Thus, upon determination of the bad block in the nonvolatile memory device 2200, the replacement block requester 2151 might simply increment a replacement block request count, since no free blocks are available in the first plane 1110C. However, this delayed approach to providing a replacement block cannot be accepted in the example of FIG. 6 because it is assumed that the replacement provision policy mandates that a bad user-defined data block must be immediately substituted by a replacement block, regardless of the number of free blocks.

Thus, in the example of FIG. 6, the bad user-defined data block 650 must be immediately substituted (of course, adhering to a definition of operations priority established for the memory system 2000) by a replacement block, despite the fact that plane 1110C does not include a single free block. Accordingly, the block generator 2154 must generate at least one free block by performed copy/merge operations between the blocks of plane 1110C and the blocks of plane 1110D. That is, the illustrated example of FIG. merges data from user-defined data blocks 670 and 680 of the first plane 1110C, and then copies the merged data into a free block 670A of the second plane 1110D. This combination of operations allows the one or both of data blocks 670 and 680 to be recycled as newly created free blocks. Either one of these newly created free blocks may be designated as a replacement block for the bad block 650.

Alternately, assuming that the block 680 A of the second plane 1110D is initially a free block, this free block—despite its disposition in a different plane from the bad block—may nonetheless be selected as a replacement block for user-defined data block 650.

In either event, the FTL may be used to update appropriate address mapping table(s) so that the logical address(es) initially corresponding to the bad block are mapped onto corresponding address(es) of the free block selected as the replacement block. In these manners, a replacement block may be immediately provided for the bad user-defined data block.

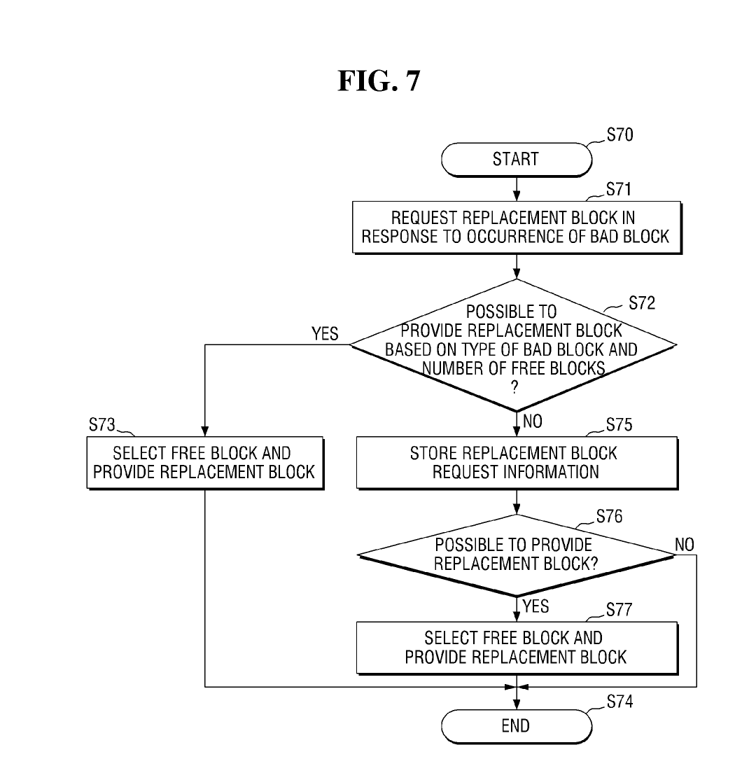

FIG. 7 is a flowchart summarizing in one example an operating method for the bad block management unit 2150 according to certain embodiments of the inventive concept.

Referring to FIGS. 3 and 7, the bad block management unit 2150 receives from the nonvolatile memory device 2200 information indicating that a bad block has been determined. Accordingly, the bad block management unit 2150 requests a replacement block (S71). The bad block management unit 2150 determines whether it is possible to provide the replacement block based on type of the bad block and the number of free blocks of the nonvolatile memory device 2200 (S72). That is, the operating A replacement block provision policy considers the type of bad block and number of free blocks. When it is possible to provide the replacement block based on the replacement block provision policy (S72=YES), the bad block management unit 2150 selects a free block and provides the selected free block as a replacement block for the bad block to the nonvolatile memory device 2200 (S73). That is, the logical address(es) of the bad block are mapped onto corresponding physical address(es) of the replacement block and mapping information may be updated in the RAM 2130 or the nonvolatile memory device 2200.

However, when it is determined that it is not possible to provide the replacement block based on the replacement block provision policy (S72=NO), the bad block management unit 2150 stores replacement block request information in the RAM 2130 or the nonvolatile memory device 2200 (S75). Then, the bad block management unit 2150 determines a later time during which a replacement block may be substituted for the bad block (S76). When it is possible to provide the replacement block, the bad block management unit 2150 selects a free block and provides the replacement block to the nonvolatile memory device 2200 (S77). However, if it proves not possible to provide the replacement block, the bad block management unit 2150 may omit provision of the replacement block and terminate the operation (S74) as the replacement block provision policy allows.

Various approaches (and corresponding thresholds) may be used to determine the type of the bad block and the number of free blocks available in a plane or group of planes.

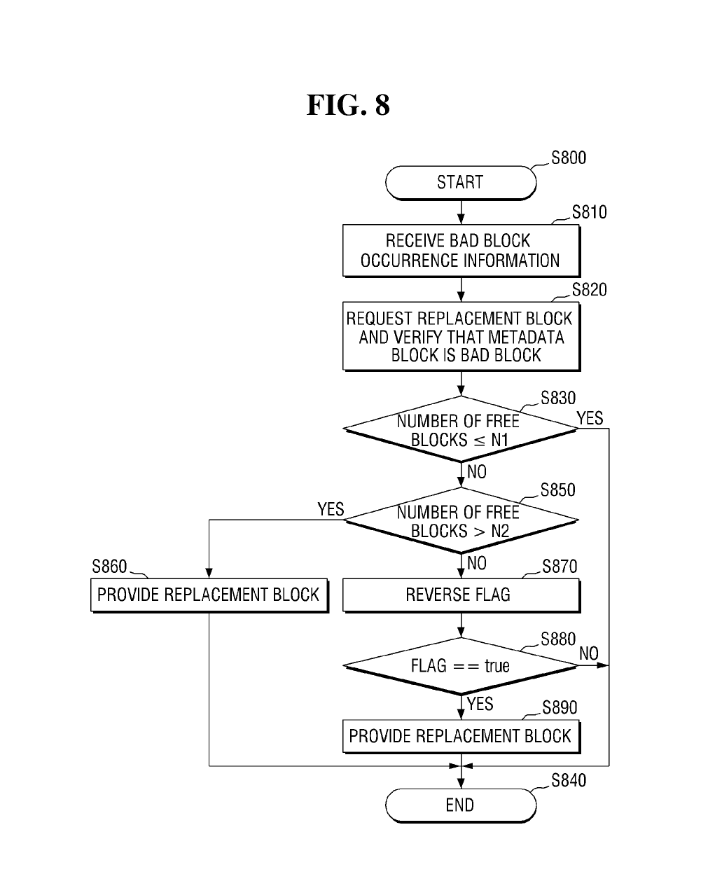

FIG. 8 is a flowchart summarizing in another example an operating method for the bad block management unit 2150 according to an embodiment of the inventive concept. FIG. 8 assumes that a metadata block has been determined to be a bad block.

Referring to FIGS. 3, 7 and 8, the bad block management unit 2150 receives bad block occurrence information (S810). The bad block management unit 2150 requests a replacement block and determines (verifies) that the type of the bad block is a metadata block (S820). The bad block management unit 2150 then determines a current number of free blocks in a plane including the bad block or a plurality of planes and compares the current number of free blocks to a first threshold N1 (S830). For example, when the number of free blocks is less than or equal to N1, the bad block management unit 2150 does not provide the replacement block and terminates the operation (S840). When the number of free blocks is greater than N1, the bad block management unit 2150 compares the number of free blocks to a second threshold N2 greater than first threshold N1 (S850). When the number of free blocks is greater than the second threshold N2, the bad block management unit 2150 selects a free block as a replacement block for the bad metadata block and provides the replacement block to the nonvolatile memory device 2200 (S860). Then, the bad block management unit 2150 terminates the operation (S840).

Assuming in one example that the first threshold N1 is 10, and the second threshold N2 is 20, then given contemporary nonvolatile memory devices, the first threshold N1 may correspond to about 0.2% to about 0.5% of the number of blocks typically available in a single plane, and the second threshold N2 may correspond to about 0.7% to about 1% thereof.

However, when the number of free blocks is not greater than the second threshold N2, the bad block management unit 2150 will reverse the setting of a flag (S870). When the reversed flag data is ‘true’, the bad block management unit 2150 then provides the replacement block to the nonvolatile memory device 2200 (S890). else terminates the operation (S840).

In this example, the flag may be provided using a binary state (0/1) toggle scheme, where “0” indicates “true” and becomes an identification mark for providing the replacement block and “1” indicates “false” and becomes an identification mark for not providing the replacement block. Accordingly, when the free blocks are secured over time, the bad block management unit 2150 may select the replacement block from among the free blocks and thereby provide the selected replacement block.

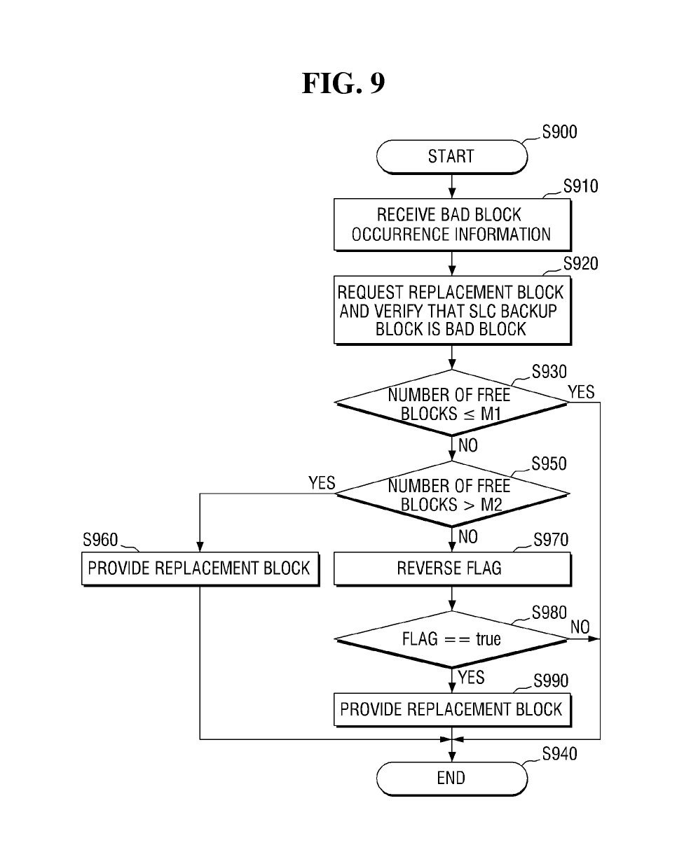

FIG. 9 is a flowchart illustrating in another example an operating method for the bad block management unit 2150 according to another embodiment of the inventive concept. FIG. 9 assumes that a SLC backup block has been determined to be a bad block.

Given this difference in the type of the bad block and comparing FIG. 8 it may be seen that the bad block management unit 2150 may operate essentially as described above, except different (or the same) first and second thresholds M1 and M2 are used in relation to the determination of bad block type.

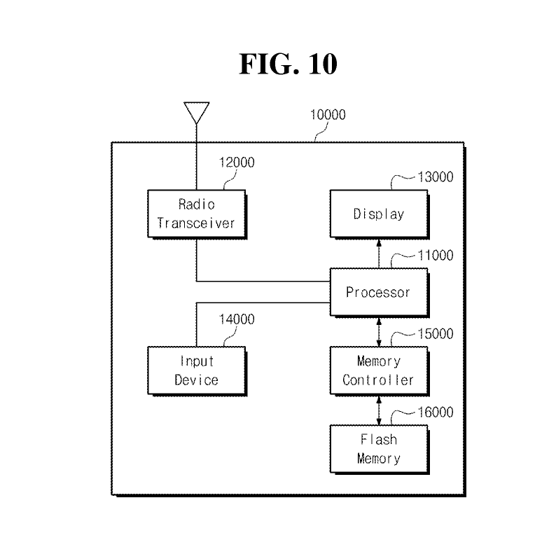

FIG. 10 is a block diagram of an electronic device 10000 including a memory controller 15000 and a nonvolatile memory device 16000 according to an embodiment of the inventive concept.

Referring to FIG. 10, the electronic device 10000, such as a cellular phone, a smart phone, or a table PC, may include the nonvolatile memory device 16000 configurable as a flash memory device and the memory controller 15000 capable of controlling an operation of the nonvolatile memory device 16000.

The nonvolatile memory device 16000 may indicate a nonvolatile memory device illustrated in FIGS. 1 and 7. The nonvolatile memory device 16000 may store random data.

The memory controller 15000 is controlled by a processor 11000 configured to control the overall operation of the electronic device 10000.

Data stored in the nonvolatile memory device 16000 may be displayed through a display 13000 according to control of the memory controller 15000 that operates according to control of the processor 11000.

A radio transceiver 12000 may transmit or receive a radio signal through an antenna ANT. For example, the radio transceiver 12000 may convert the radio signal received through the antenna ANT to a signal that can be processed by the processor 11000. Accordingly, the processor 11000 may process a signal output from the radio transceiver 12000, and may store the processed signal in the nonvolatile memory device 16000 through the memory controller 15000 or may display the processed signal through the display 13000.

The radio transceiver 12000 may convert the signal output from the processor 11000 to the radio signal, and may output the converted radio signal to an outside through the antenna ANT.

An input device 14000 refers to a device capable of inputting a control signal for controlling an operation of the processor 11000 or data to be processed by the processor 11000, and may be configured as a pointing device such as a touch pad and a computer mouse, a keypad, or a keyboard.

The processor 11000 may control the display 13000 so that data output from the nonvolatile memory device 16000, the radio signal output from the radio transceiver 12000, or data output from the input device 14000 may be displayed through the display 13000.

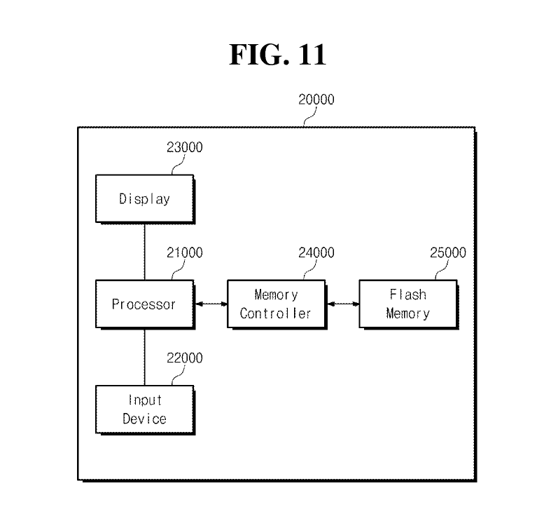

FIG. 11 is a block diagram of an electronic device 20000 including a memory controller 24000 and a nonvolatile memory device 25000 according to another embodiment of the inventive concept.

Referring to FIG. 11, the electronic device 20000 configurable as a data processing device such as a PC, a tablet computer, a net-book, an e-reader, a PDA, a portable multimedia player (PMP), an MP3 player, or an MP4 player includes the nonvolatile memory device 25000 such as a flash memory device and the memory controller 24000 capable of controlling an operation of the nonvolatile memory device 25000.

The nonvolatile memory device 25000 may indicate a nonvolatile memory device illustrated in FIGS. 1 and 11. The nonvolatile memory device 25000 may store random data.

The electronic device 20000 may include a processor 21000 configured to control the overall operation of the electronic device 20000. The memory controller 24000 is controlled by the processor 21000.

The processor 21000 may display data stored in the nonvolatile memory device 25000 through a display 23000 based on an input signal generated by an input device 22000. For example, the input device 22000 may be configured as a pointing device such as a touch pad or a computer mouse, a keypad, or a keyboard.

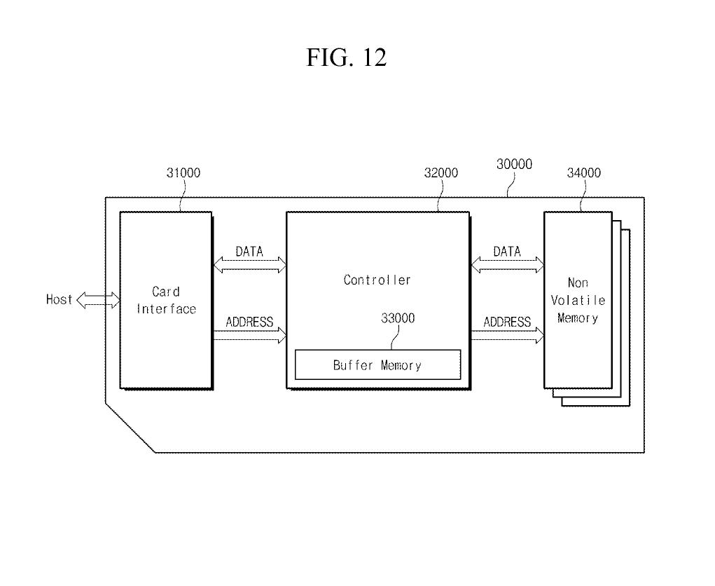

FIG. 12 is a block diagram of an electronic device 30000 including a nonvolatile memory device 34000 according to still another embodiment of the inventive concept.

Referring to FIG. 12, the electronic device 30000 includes a card interface 31000, a memory controller 32000, and the nonvolatile memory device 34000, for example, a flash memory device.

The electronic device 30000 may transmit or receive data to or from a host through the card interface 31000. Depending on embodiments, the card interface 31000 may be a secure digital (SD) card interface or a multi-media card (MMC) card interface, but the inventive concept is not limited thereto. The card interface 31000 may interface data exchange between the host and the memory controller 32000 according to a communication protocol of the host capable of communicating with the electronic device 30000.

The memory controller 32000 may control the overall operation of the electronic device 30000, and may control exchange of data between the card interface 31000 and the nonvolatile memory device 34000. Also, a buffer memory 33000 of the memory controller 32000 may buffer data transmitted and received between the card interface 31000 and the nonvolatile memory device 34000.

The memory controller 32000 connects to the card interface 31000 and the nonvolatile memory device 34000 through a data bus (DATA) and an address bus (ADDRESS). Depending on embodiments, the memory controller 32000 receives, from the card interface 31000, an address of data desired to be read or written and transmits the received address to the nonvolatile memory device 34000 through the address bus (ADDRESS).

Also, the memory controller 32000 receives or transmits data desired to be read or written through the data bus (DATA) connected to each of the card interface 31000 and the nonvolatile memory device 34000.

The nonvolatile memory device 34000 may indicate the nonvolatile memory device of FIG. 1. The nonvolatile memory device 34000 may store random data.

When the electronic device 30000 of FIG. 12 connects to the host such as a PC, a table PC, a digital camera, a digital audio player, a cellular phone, console video game hardware, or a digital set-top box, the host may transmit or receive data stored in the nonvolatile memory device 34000 to or from the card interface 31000 through the memory controller 32000.

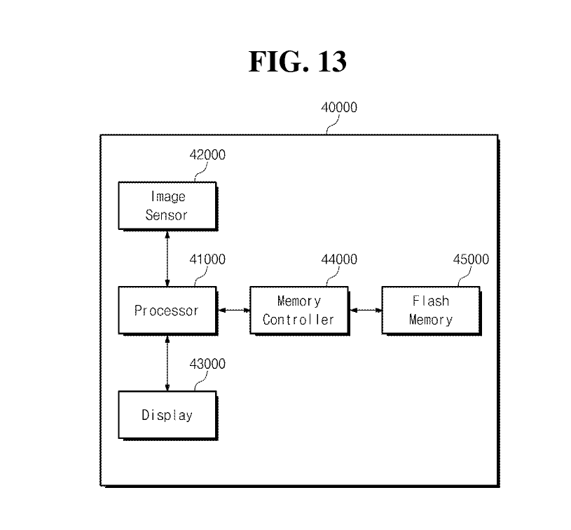

FIG. 13 is a block diagram of an electronic device 40000 including a memory controller 44000 and a nonvolatile memory device 45000 according to yet another embodiment of the inventive concept.

Referring to FIG. 13, the electronic device 40000 includes the nonvolatile memory device 45000 such as a flash memory device, the memory controller 44000 configured to control a data processing operation of the nonvolatile memory device 45000, and a processor 41000 capable of controlling the overall operation of the electronic device 40000.

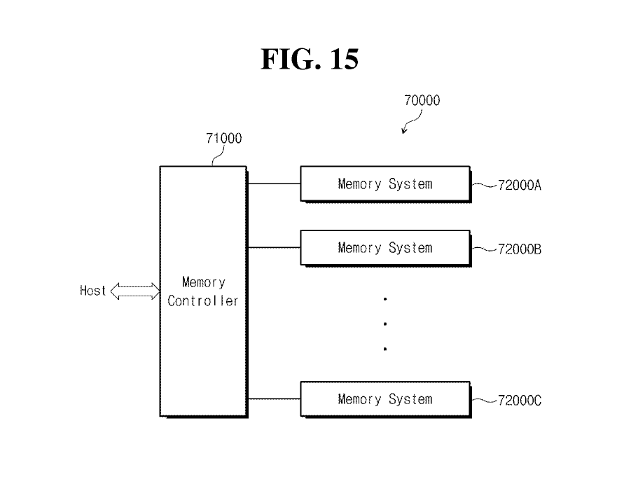

The nonvolatile memory device 45000 may indicate the nonvolatile memory device of FIGS. 1 and 15.

An image sensor 42000 of the electronic device 40000 converts an optical signal to a digital signal. The converted digital signal is stored in the nonvolatile memory device 45000 or displayed through a display 43000 according to control of the image sensor 41000. Also, the digital signal stored in the nonvolatile memory device 45000 is displayed through the display 43000 according to control of the processor 41000.

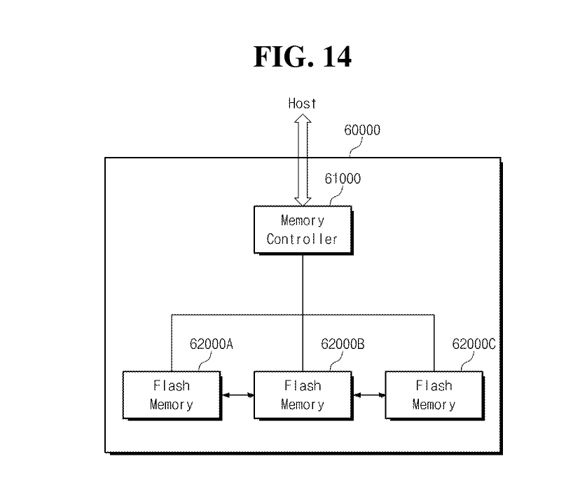

FIG. 14 is a block diagram of an electronic device 60000 including a memory controller 61000 and nonvolatile memory devices 62000A, 62000B, and 62000C according to further another embodiment of the inventive concept.

Referring to FIG. 14, the electronic device 6000 may be configured as a data storage device such as a solid state drive (SSD).

The electronic device 60000 may include a plurality of nonvolatile memory devices 62000A, 62000B, and 62000C, and the memory controller 61000 capable of controlling a data processing operation of each of the plurality of nonvolatile memory devices 62000A, 62000B, and 62000C.

The electronic device 60000 may be configured as a memory system or a memory module.

Each of the nonvolatile memory devices 62000A, 62000B, and 62000C may indicate the nonvolatile memory device of FIGS. 1 and 15. The nonvolatile memory devices 62000A, 62000B, and 62000C may store random data.

Depending on embodiments, the memory controller 61000 may be configured within or outside the electronic device 60000.

FIG. 15 is a block diagram illustrating a data processing system including the electronic device of FIG. 14.

Referring to FIGS. 14 and 15, a data storage device 70000 configurable as a redundant array of independent disks (RAID) system may include a RAID controller 71000 and a plurality of memory systems 72000A, 72000B˜72000N (N denotes a natural number).

Each of the plurality of memory systems 72000A, 72000B˜72000N may be the electronic device 40000 of FIG. 13. The plurality of memory systems 72000A, 72000B˜72000N may constitute an RAID array. The data storage device 70000 may be configured as a PC or an SSD.

During a program operation, the RAID controller 71000 may output program data output from a host to any one memory system among the plurality of memory systems 72000A, 72000B˜72000N, based on any one RAID level that is selected from among a plurality of RAID levels based on RAID level information output from the host.

Also, during a read operation, the RAID controller 71000 may transmit, to the host, data read from any one memory system among the plurality of memory systems 72000A, 72000B˜72000N, based on any one RAID level that is selected from among a plurality of RAID levels based on RAID level information output from the host.

Those skilled in the art will appreciate that many variations and modifications may be made to the illustrated embodiments without substantially departing from the principles of the inventive concept. Therefore, the illustrated embodiments of the inventive concept should be read in a generic and descriptive sense and not for purposes of limitation.

What is claimed is:

1. A memory controller that controls operation of a nonvolatile memory device that stores data according to a plurality of blocks, the memory controller comprising:
a bad block management unit that provides a replacement block as a substitute for a block determined to be bad block, wherein the bad block management unit includes;
a replacement block requester that determines that a block among the blocks of the nonvolatile memory device is a bad block, and upon determining that the block is a bad block requests a replacement block; and
a replacement block provider responsive to the request of the replacement block requester and controlled by a replacement block provision policy that provides the replacement block for the bad block by considering a type of the block and a current number of free blocks.

2. The memory controller of claim 1, wherein the replacement block provider comprises a provision policy check unit that operates in response to replacement block provision policy to determine the type of the block and the number of free blocks.

3. The memory controller of claim 2, wherein the replacement block provider further comprises a block generator that generates an additional free block in response to the replacement block provision policy.

4. The memory controller of claim 3, wherein the replacement block provider further comprises a block selector that selects a free block among the number of free blocks as the replacement bock and provides the selected replacement block to the nonvolatile memory device.

5. The memory controller of claim 4, wherein upon providing the replacement block to the nonvolatile memory device, logical address(es) of the block determined to be the bad block are converted into corresponding physical address(es) of the replacement block.

6. The memory controller of claim 5, wherein the nonvolatile memory device is a flash memory device and a flash translation layer (FTL) running on the memory controller converts the logical address(es) of the block determined to be the bad block into the corresponding physical address(es) of the replacement block.

7. The memory controller of claim 1, wherein upon determining that the type of the bad block is a user-defined data block type, the replacement block provider immediately provides the replacement block regardless of the current number of free blocks.

8. The memory controller of claim 1, wherein upon determining that the type of the bad block is one of a metadata block type and a single-level memory cell (SLC) backup block, and further upon determining that the current number of free blocks is less than a minimum threshold, the replacement block provider does not immediately provide the replacement block.

9. The memory controller of claim 1, wherein that the replacement block requester determines that the block is a bad block in response to a command execution failure signal provided by the nonvolatile memory device.

10. The memory controller of claim 1, wherein the nonvolatile memory device is a flash memory device arranging flash memory cells in a plurality of planes, and
the number of free blocks is determined for only a single plane including the bad block among the plurality of planes.

11. The memory controller of claim 1, wherein the nonvolatile memory device is a flash memory device arranging flash memory cells in a plurality of planes, and
the number of free blocks is determined for at least two of the plurality of planes.

12. An operating method for a memory controller that controls the operation of a nonvolatile memory device that stores data according to a plurality of multiple blocks, the method comprising:
determining that a block among the plurality of blocks is a bad block; and then,
determining a type of the bad block, and determining a number of free blocks; and
providing a replacement block to the nonvolatile memory device for the bad block using a replacement block provision policy that is responsive to the type of the bad block and the number of free blocks.

13. The method of claim 12, further comprising:
upon providing the replacement block to the nonvolatile memory device, converting the logical address(es) of the bad block into corresponding physical address(es) of the replacement block; and
updating an address mapping table storing information describing the converting of the logical address(es) of the bad block into corresponding physical address(es) of the replacement block.

14. The method of claim 13, wherein the nonvolatile memory device is a flash memory device and a flash translation layer (FTL) running on the memory controller converts the logical address(es) of the bad block into the corresponding physical address(es) of the replacement block.

15. The method of claim 12, wherein upon determining that the type of the bad block is a user-defined data block type, the replacement block is immediately provided by the nonvolatile memory device regardless of the current number of free blocks.

16. The method of claim 12, wherein upon determining that the type of the bad block is one of a metadata block type and a single-level memory cell (SLC) backup block, and upon further determining that the current number of free blocks is less than a minimum threshold, the replacement block is not immediately provided to the nonvolatile memory device and instead replacement block request information is stored in a random access memory (RAM).

17. The method of claim 12, wherein determining that the block among the plurality of blocks is a bad block is performed in response to a command execution failure signal received in the memory controller from the nonvolatile memory device.

18. The method of claim 12, wherein the nonvolatile memory device is a flash memory device arranging flash memory cells in a plurality of planes, and
the number of free blocks is determined for only a single plane including the bad block among the plurality of planes.

19. The method controller of claim 1, wherein the nonvolatile memory device is a flash memory device arranging flash memory cells in a plurality of planes, and
the number of free blocks is determined for at least two of the plurality of planes.

20. The method of claim 12, wherein upon determining that the number of free blocks is less than a minimum threshold, the method further comprises performing a garbage collection operation.
